(19) United States
(12) Patent Application Publication
(10) Pub. No.: US 2026/0277710 A1
(43) Pub. Date: Sep. 17, 2026

(54) OFF-SYSTEM TELEMETRY TRANSMISSION IN A MULTI-APPLICATION ENVIRONMENT

(71) Applicant: Dell Products L.P., Round Rock, TX (US)

(72) Inventors: Alan Helmy Abdelhalim, Pflugerville, TX (US); Jacob Vincent Mink, Cedar Park, TX (US)

(21) Appl. No.: 19/078,685

(22) Filed: Mar. 13, 2025

(51) Int. Cl. G06F 9/54

(52) U.S. Cl. CPC G06F 9/542

(57) ABSTRACT

An embodiment receives, from a first application, a first data transmission request comprising a destination information handling system, a first data identifier, and a first data portion, the first application executing on a first information handling system. An embodiment determines that the first data identifier is present in a transmission record of data identifiers transmitted from the first information handling system. An embodiment deletes, responsive to determining that the first data identifier is present in the transmission record, the first data portion from the first data transmission request, the deleting resulting in a modified first data transmission request. An embodiment transmits the modified first data transmission request from the first information handling system to the destination information handling system.

### BACKGROUND

### Field of the Disclosure

The disclosure relates generally to an information handling system, and in particular, to off-system telemetry transmission in a multi-application environment.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some information handling systems incorporate a telemetry manager, a software platform incorporating telemetry, cloud-based analytics, and data transmission to monitor and report status of the information handling system and its components. Automatically collecting and analyzing telemetry helps an information handling system supplier accurately and efficiently diagnose issues on customer devices and provide the right solutions on the first try and decreases productivity interruption by proactively predicting or detecting device health issues before or as soon as they arise. The telemetry manager supports on-demand, periodic, and event or trigger-based data workflows across collection, analytics, and transmission data operations. The telemetry manager is single-instanced and shared by information handling system management applications and services to optimize performance on user systems. Client application software development kids (SDKs) present a declarative, data-oriented perspective, prioritizing discoverability and ease of use by data scientists and application developers. The platform provides a secure, “Local Data Lake” on the information handling system including raw collected data, locally-computed analytics, and diagnostic test results. Offloading work to a cloud-based system enables faster, actionable insights computed locally and reduces the amount of data transmitted to the cloud by default. The platform provides extensibility mechanisms that allow platform extendibility via new or updated analytics plug-ins. The platform provides a management model where individual “datatypes” have associated configuration settings used to dynamically optimize the frequency of their collection, computation, and transmission. The platform defines a core set of telemetry to be collected/computed and transmitted by default, with the rest lying in dormant mode, available to produce and transmit per optional administrator configuration or client requests. The platform supports client application configuration profiles and batch requests that allow applications to easily configure their periodic or ongoing telemetry and analytics requirements or batch on-demand requests. The platform merges application requests to single-instance and optimizes operations without further application input.

### SUMMARY

Innovative aspects of the subject matter described in this specification may be embodied in a method comprising: receiving, from a first application, a first data transmission request comprising a destination information handling system, a first data identifier, and a first data portion, the first application executing on a first information handling system; determining that the first data identifier is present in a transmission record of data identifiers transmitted from the first information handling system; deleting, responsive to determining that the first data identifier is present in the transmission record, the first data portion from the first data transmission request, the deleting resulting in a modified first data transmission request; and transmitting the modified first data transmission request from the first information handling system to the destination information handling system.

Other embodiments of these aspects include corresponding systems, apparatus, and computer programs, configured to perform the actions of the methods, encoded on computer storage devices.

Particular implementations of the subject matter described in this specification can be implemented so as to realize one or more of the following advantages. For example, the implementations meet a need to reduce duplicate data transmission and storage off-system as much as possible, improving the user experience.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 depicts a block diagram of an example configuration for off-system telemetry transmission in a multi-application environment, according to some embodiments.

FIG. 3 depicts an example of off-system telemetry transmission in a multi-application environment, in accordance with an illustrative embodiment.

FIG. 4 depicts a flowchart of an example process for off-system telemetry transmission in a multi-application environment. in accordance with an illustrative embodiment.

### DESCRIPTION OF PARTICULAR EMBODIMENT(S)

A telemetry manager in presently available information handling systems is able to transmit telemetry data off-system, for example to another information handling system executing in a cloud environment. Because the telemetry manager supports multiple applications and multiple types of analyses, multiple applications might need to transmit different types of telemetry data to more than one off-system location. For example, a support assistant application using the telemetry manager might transmit CPU analysis data daily to one location and transmit memory analysis data to a second location. An optimizer application using the telemetry manager might transmit memory analysis data to the first location.

A common cloud landing zone can be used to route data where it needs to go at a destination information handling system. However, multiple applications using the telemetry manager to transmit data can end up requesting the same data to be transmitted without knowing the other application has already sent it to the landing zone. This incurs unnecessary costs to transmit data twice as well as storage costs for duplicate data.

Thus, the illustrative embodiments recognize that there is a need to reduce duplicate data transmission and storage off-system as much as possible, improving the user experience.

This disclosure discusses methods and systems for off-system telemetry transmission in a multi-application environment of an information handling system. In particular, an embodiment receives, from a first application, a first data transmission request comprising a destination information handling system, a first data identifier, and a first data portion, the first application executing on a first information handling system; determines that the first data identifier is present in a transmission record of data identifiers transmitted from the first information handling system; deletes, responsive to determining that the first data identifier is present in the transmission record, the first data portion from the first data transmission request, the deleting resulting in a modified first data transmission request; and transmits the modified first data transmission request from the first information handling system to the destination information handling system.

An embodiment executes in a data transmission service of a telemetry management platform of an information handling system. One or more applications executing on the same information handling system send data transmission requests to the data transmission service for transmission to a destination system. A data transmission request includes a destination information handling system, a data identifier, and a data portion identified by the data identifier. A data identifier includes a datatype identifier representing the type of data in the data portion, an item identifier identifying the item the data in the data portion came from, and a group identifier identifying a group of data records (in the data portion) that were created together. For example, if MemoryAnalysis, telemetry data with datatype ID 5, is run on all four dual in-line memory modules (DIMMs) in a system, then the data produced would have data identifiers of {DatatypeId: 5, ItemId: DIMM_0, GroupId: 1}, {DatatypeId: 5, ItemId: DIMM_1, GroupId: 1}, {DatatypeId: 5, ItemId: DIMM_2, GroupId: 1}, and {DatatypeId: 5, ItemId: DIMM_3, GroupId: 1}.

An embodiment receives a data transmission request, including a data identifier identifying a data portion, from a first application executing on the same information handling system as the embodiment. An embodiment checks whether the data identifier is present in a transmission record of data identifiers transmitted from the system. If an embodiment determines that the data identifier is absent from the transmission record, the data portion referenced by the data identifier has not yet been transmitted to the destination system. Thus, an embodiment transmits the data transmission request (including the data identifier and the data portion) to the destination system and records the data identifier in the transmission record for later. The destination system stores the data identifier and data portion for use by an application at the destination system or another system.

If an embodiment determines that the first data identifier is present in a transmission record of data identifiers transmitted from the information handling system, the data portion referenced by the data identifier has already been transmitted to the destination system and need not be transmitted again. Thus, an embodiment deletes the data portion from the data transmission request and transmits the modified data transmission request to the destination system. The destination system, upon receiving the data identifier without a corresponding data portion, looks up the previously stored data portion and routes it to an appropriate application at destination system or another system.

If an embodiment determines that data in a data transmission request partially overlaps data already transmitted (i.e., one data identifier in the request is present in a transmission record of data identifiers transmitted from the system and another data identifier in the request is absent from the transmission record), the data portion referenced by the data identifier present in the transmission record has already been transmitted to the destination system and need not be transmitted again. Thus, an embodiment deletes the data portion identified by the data identifier already in the transmission record from the data transmission request (leaving the not previously transmitted data portion in the data transmission request) and transmits the modified data transmission request to the destination system. An embodiment records the data identifier of the not previously transmitted data portion in the transmission record for later.

An embodiment retains entries in the transmission record until the data portion is removed from a data collection or data analytics database maintained by the telemetry platform. When the data portion is removed from a data collection or data analytics database maintained by the telemetry platform, an embodiment deletes the corresponding entry from the transmission record.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

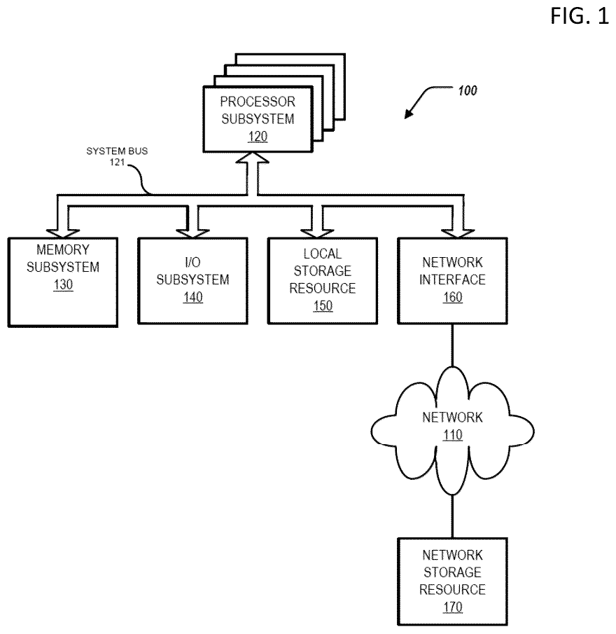

Particular embodiments are best understood by reference to FIGS. 1-4 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

The information handling system 100 can also include a software application implementing off-system telemetry transmission in a multi-application environment. The software application can be included by the memory subsystem 130. The software application can include a computer-executable program (software). The software application can be executed by the processor subsystem 120.

The information handling system 100 can also include a second software application implementing embedded controller functionality. The second software application can be in communication with the processor subsystem 120 or included in the processor subsystem 120. In some examples, the second software application is included by an embedded controller (EC) of the information handling system 100. In some examples, the second software application is included by baseband management controller of the information handling system 100.

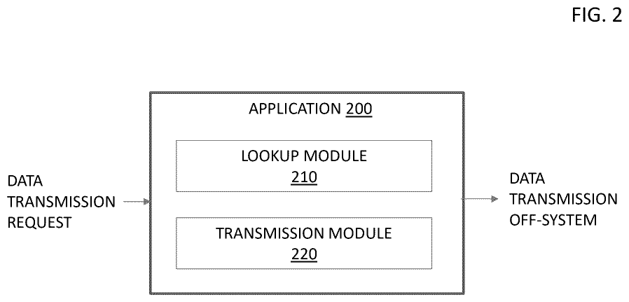

FIG. 2 depicts a block diagram of an example configuration for off-system telemetry transmission in a multi-application environment, according to some embodiments.

Application 200 executes in a data transmission service of a telemetry management platform of an information handling system. One or more applications executing on the same information handling system send data transmission requests to the data transmission service for transmission to a destination system. A data transmission request includes a destination information handling system, a data identifier, and a data portion identified by the data identifier. A data identifier includes a datatype identifier representing the type of data in the data portion, an item identifier identifying the item the data in the data portion came from, and a group identifier identifying a group of data records (in the data portion) that were created together. For example, if MemoryAnalysis, telemetry data with datatype ID 5, is run on all four dual in-line memory modules (DIMMs) in a system, then the data produced would have data identifiers of {DatatypeId: 5, ItemId: DIMM_0, GroupId: 1}, {DatatypeId: 5, ItemId: DIMM_1, GroupId: 1}, {DatatypeId: 5, ItemId: DIMM_2, GroupId: 1}, and {DatatypeId: 5, ItemId: DIMM_3, GroupId: 1}.

Lookup module 210 receives a data transmission request, including a data identifier identifying a data portion, from a first application executing on the same information handling system as the embodiment. Module 210 checks whether the data identifier is present in a transmission record of data identifiers transmitted from the system. If module 210 determines that the data identifier is absent from the transmission record, the data portion referenced by the data identifier has not yet been transmitted to the destination system. Thus, transmission module 220 transmits the data transmission request (including the data identifier and the data portion) to the destination system and records the data identifier in the transmission record for later. The destination system stores the data identifier and data portion for use by an application at the destination system or another system.

If module 210 determines that the first data identifier is present in a transmission record of data identifiers transmitted from the information handling system, the data portion referenced by the data identifier has already been transmitted to the destination system and need not be transmitted again. Thus, module 220 deletes the data portion from the data transmission request and transmits the modified data transmission request to the destination system. The destination system, upon receiving the data identifier without a corresponding data portion, looks up the previously stored data portion and routes it to an appropriate application at destination system or another system.

If module 210 determines that data in a data transmission request partially overlaps data already transmitted (i.e., one data identifier in the request is present in a transmission record of data identifiers transmitted from the system and another data identifier in the request is absent from the transmission record), the data portion referenced by the data identifier present in the transmission record has already been transmitted to the destination system and need not be transmitted again. Thus, module 220 deletes the data portion identified by the data identifier already in the transmission record from the data transmission request (leaving the not previously transmitted data portion in the data transmission request) and transmits the modified data transmission request to the destination system. Application 200 records the data identifier of the not previously transmitted data portion in the transmission record for later.

Application 200 retains entries in the transmission record until the data portion is removed from a data collection or data analytics database maintained by the telemetry platform. When the data portion is removed from a data collection or data analytics database maintained by the telemetry platform, an embodiment deletes the corresponding entry from the transmission record.

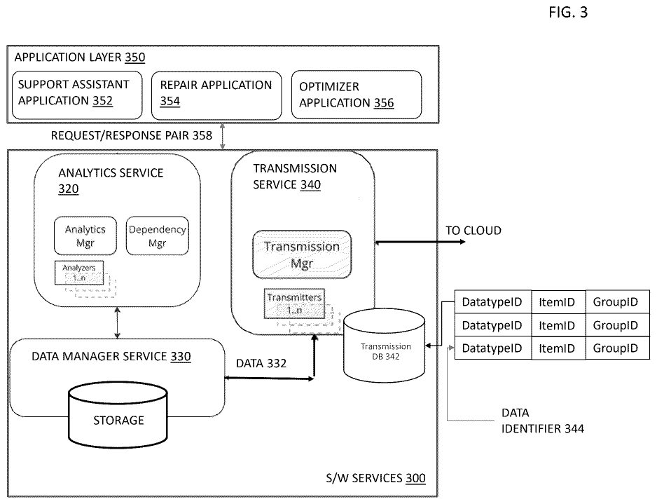

FIG. 3 depicts an example of off-system telemetry transmission in a multi-application environment, in accordance with an illustrative embodiment. The example can be executed using application 200 in FIG. 2.

A telemetry manager platform includes one or more data services. A data service of the telemetry manager platform produces data. For example, data manager service 330 stores and manages historical, i.e., already collected, data.

Application 200 executes in data transmission service 340 of a telemetry management platform of an information handling system such as information handling system 100 in FIG. 1. One or more applications executing on the same information handling system (e.g., support assistant application 352, repair application 354, and optimizer application 356 in application layer 350) send data transmission requests (e.g., request/response pair 358) to data transmission service 340, in software services 300, for transmission to a destination system. A data transmission request includes a destination information handling system, a data identifier, and a data portion identified by the data identifier. A data identifier (e.g., data identifier 344) includes a datatype identifier representing the type of data in the data portion, an item identifier identifying the item the data in the data portion came from, and a group identifier identifying a group of data records (in the data portion) that were created together. For example, if MemoryAnalysis, telemetry data with datatype ID 5, is run on all four dual in-line memory modules (DIMMs) in a system, then the data produced would have data identifiers of {DatatypeId: 5, ItemId: DIMM_0, GroupId: 1}, {DatatypeId: 5, ItemId: DIMM_1, GroupId: 1}, {DatatypeId: 5, ItemId: DIMM_2, GroupId: 1}, and {DatatypeId: 5, ItemId: DIMM_3, GroupId: 1}.

Applications 352, 354, and 356 also send analytics requests to the telemetry manager, which routes analytics requests to analytics service 320 for fulfillment using one or more analytics plug-ins. Analytics service 320, as well as other services within software services 300, store data using data manager server 330.

Data transmission service 340 receives a data transmission request (e.g., part of request/response pair 358), including a data identifier identifying a data portion, from an application in application layer 350, executing on the same information handling system as application 200. Application 200 receives data 332 from data manager service 330. (Data to transmit may also arrive from a different source.) Application 200 checks whether the data identifier is present in transmission database (DB) 342), a transmission record of data identifiers transmitted from the system, including data identifier 344. Application 200 uses transmission DB 342 to determine whether to send a data portion, or simply a data identifier, to a destination system.

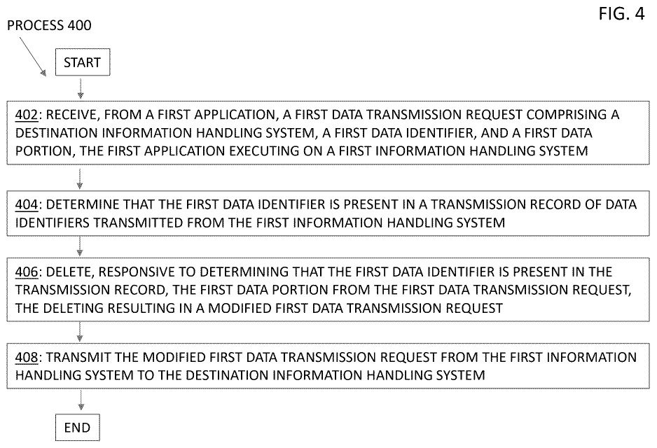

FIG. 4 depicts a flowchart of an example process for off-system telemetry transmission in a multi-application environment. in accordance with an illustrative embodiment. Process 400 can be executed using application 200 in FIG. 2.

In block 402, the process receives, from a first application, a first data transmission request comprising a destination information handling system, a first data identifier, and a first data portion, the first application executing on a first information handling system. In block 404, the process determines that the first data identifier is present in a transmission record of data identifiers transmitted from the first information handling system. In block 406, the process deletes, responsive to determining that the first data identifier is present in the transmission record, the first data portion from the first data transmission request, the deleting resulting in a modified first data transmission request. In block 408, the process transmits the modified first data transmission request from the first information handling system to the destination information handling system. Then the process ends.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method comprising:
receiving, from a first application, a first data transmission request comprising a destination information handling system, a first data identifier, and a first data portion, the first application executing on a first information handling system;
determining that the first data identifier is present in a transmission record of data identifiers transmitted from the first information handling system;
deleting, responsive to determining that the first data identifier is present in the transmission record, the first data portion from the first data transmission request, the deleting resulting in a modified first data transmission request; and
transmitting the modified first data transmission request from the first information handling system to the destination information handling system.

2. The computer-implemented method of claim 1, wherein the first data identifier comprises a datatype identifier, an item identifier, and a group identifier corresponding to the first data portion.

3. The computer-implemented method of claim 1, wherein the first data transmission request is received at a data transmission service of a telemetry management platform of the first information handling system.

4. The computer-implemented method of claim 1, further comprising:
receiving, from a second application, a second data transmission request comprising the destination information handling system, a second data identifier, and a second data portion, the second application executing on the first system;
determining that second data identifier is absent from the transmission record; and
transmitting, responsive to determining that the second data identifier is absent from the transmission record, the second data transmission request to the destination information handling system.

5. The computer-implemented method of claim 4, wherein transmitting the second data identifier and the second data portion from the first system to the destination information handling system comprises recording the first data identifier in the transmission record.

6. The computer-implemented method of claim 1, further comprising:
receiving, from a third application, a third data transmission request comprising the destination information handling system, the first data identifier, the first data portion, a third data identifier, and a third data portion, the third application executing on the first information handling system;
determining that first data identifier is present in the transmission record and the third data identifier is absent from the transmission record;
deleting, responsive to determining that the first data identifier is present in the transmission record and the third data identifier is absent from the transmission record, the first data portion from the third data transmission request, the deleting resulting in a modified third data transmission request; and
transmitting the modified third data transmission request from the first information handling system to the destination information handling system.

7. The computer-implemented method of claim 6, wherein transmitting the modified third data transmission request from the first information handling system to the destination information handling system comprises recording the third data identifier in the transmission record.

8. An information handling system comprising a processor having access to memory media storing instructions executable by the processor to perform operations, comprising:
receiving, from a first application, a first data transmission request comprising a destination information handling system, a first data identifier, and a first data portion, the first application executing on a first information handling system;
determining that the first data identifier is present in a transmission record of data identifiers transmitted from the first information handling system;
deleting, responsive to determining that the first data identifier is present in the transmission record, the first data portion from the first data transmission request, the deleting resulting in a modified first data transmission request; and
transmitting the modified first data transmission request from the first information handling system to the destination information handling system.

9. The information handling system of claim 8, wherein the first data identifier comprises a datatype identifier, an item identifier, and a group identifier corresponding to the first data portion.

10. The information handling system of claim 8, wherein the first data transmission request is received at a data transmission service of a telemetry management platform of the first information handling system.

11. The information handling system of claim 8, further comprising:
receiving, from a second application, a second data transmission request comprising the destination information handling system, a second data identifier, and a second data portion, the second application executing on the first system;
determining that second data identifier is absent from the transmission record; and
transmitting, responsive to determining that the second data identifier is absent from the transmission record, the second data transmission request to the destination information handling system.

12. The information handling system of claim 11, wherein transmitting the second data identifier and the second data portion from the first system to the destination information handling system comprises recording the first data identifier in the transmission record.

13. The information handling system of claim 8, further comprising:
receiving, from a third application, a third data transmission request comprising the destination information handling system, the first data identifier, the first data portion, a third data identifier, and a third data portion, the third application executing on the first information handling system;
determining that first data identifier is present in the transmission record and the third data identifier is absent from the transmission record;
deleting, responsive to determining that the first data identifier is present in the transmission record and the third data identifier is absent from the transmission record, the first data portion from the third data transmission request, the deleting resulting in a modified third data transmission request; and
transmitting the modified third data transmission request from the first information handling system to the destination information handling system.

14. The information handling system of claim 13, wherein transmitting the modified third data transmission request from the first information handling system to the destination information handling system comprises recording the third data identifier in the transmission record.

15. A non-transitory computer-readable medium storing software comprising instructions executable by one or more computers which, upon such execution, cause the one or more computers to perform operations comprising:
receiving, from a first application, a first data transmission request comprising a destination information handling system, a first data identifier, and a first data portion, the first application executing on a first information handling system;
determining that the first data identifier is present in a transmission record of data identifiers transmitted from the first information handling system;
deleting, responsive to determining that the first data identifier is present in the transmission record, the first data portion from the first data transmission request, the deleting resulting in a modified first data transmission request; and
transmitting the modified first data transmission request from the first information handling system to the destination information handling system.

16. The non-transitory computer-readable medium of claim 15, wherein the first data identifier comprises a datatype identifier, an item identifier, and a group identifier corresponding to the first data portion.

17. The non-transitory computer-readable medium of claim 15, wherein the first data transmission request is received at a data transmission service of a telemetry management platform of the first information handling system.

18. The non-transitory computer-readable medium of claim 15, further comprising:
receiving, from a second application, a second data transmission request comprising the destination information handling system, a second data identifier, and a second data portion, the second application executing on the first system;
determining that second data identifier is absent from the transmission record; and
transmitting, responsive to determining that the second data identifier is absent from the transmission record, the second data transmission request to the destination information handling system.

19. The non-transitory computer-readable medium of claim 18, wherein transmitting the second data identifier and the second data portion from the first system to the destination information handling system comprises recording the first data identifier in the transmission record.

20. The non-transitory computer-readable medium of claim 15, further comprising:
receiving, from a third application, a third data transmission request comprising the destination information handling system, the first data identifier, the first data portion, a third data identifier, and a third data portion, the third application executing on the first information handling system;
determining that first data identifier is present in the transmission record and the third data identifier is absent from the transmission record;
deleting, responsive to determining that the first data identifier is present in the transmission record and the third data identifier is absent from the transmission record, the first data portion from the third data transmission request, the deleting resulting in a modified third data transmission request; and
transmitting the modified third data transmission request from the first information handling system to the destination information handling system.
